(19) United States
(12) Patent Application Publication
(10) Pub. No.: US 2026/0116496 A1
(43) Pub. Date: Apr. 30, 2026

(54) DERAILLEUR HANGER

(71) Applicant: Shimano Inc., Osaka (JP)

(72) Inventors: Tadahisa SHIMOMURA, Osaka (JP); Shouta SUYAMA, Osaka (JP); Shinichiro NODA, Osaka (JP)

(21) Appl. No.: 18/930,445

(22) Filed: Oct. 29, 2024

(51) Int. Cl. B62M 9/125

(52) U.S. Cl. CPC B62M 9/125

(57) ABSTRACT

A derailleur hanger includes a first portion, a second portion, a third portion and a pin. The first portion includes an axle receiving bore for receiving a hub axle. The second portion includes a derailleur support surface for supporting a derailleur. The third portion includes a first surface facing in a first direction, a second surface facing in a second direction opposite the first direction, and a third surface facing in the first direction. The pin includes a first part coupled to the third portion, a second part projecting in the first direction from the third surface to be received in a pin receiving portion of a bicycle frame, and a frangible part disposed between the first part and the second part. The frangible part breaks relative to the first part and the second part upon application of a predetermined force or higher to the pin.

### BACKGROUND

### Technical Field

This disclosure generally relates to a derailleur hanger. More specifically, the present disclosure relates to a derailleur hanger for mounting a derailleur to a frame of a bicycle.

### Background Information

Some bicycles have a multi-gear transmission in which a gear ratio of the transmission can be changed to enable a rider to go faster or climb hills more easily. For example, some bicycles have a derailleur that is configured to shift a chain from one sprocket to an adjacent sprocket. In some bicycles, the frame of the bicycle is provided with a derailleur hanger for attaching the derailleur to the frame of the bicycle. The derailleur hanger is separate from the frame of the bicycle. The derailleur hanger generally has one end fixed to the frame of the bicycle and the other end connected to the derailleur. One example of a derailleur hanger is disclosed in U.S. Pat. No. 9,227,465 B2 (assigned to Shimano Inc.).

### SUMMARY

Generally, the present disclosure is directed to various features of a derailleur hanger for a bicycle.

In view of the state of the known technology and in accordance with a first aspect of the present disclosure, a derailleur hanger is provided that basically comprises a first portion, a second portion, a third portion and a pin. The first portion includes an axle receiving bore configured to receive a hub axle. The second portion includes a derailleur support surface configured to support a derailleur. The third portion is coupled the first portion and the second portion. The third portion includes a first surface facing in a first direction, a second surface facing in a second direction opposite the first direction, and a third surface facing in the first direction. The pin includes a first part coupled to the third portion, a second part projecting in the first direction from the third surface to be received in a pin receiving portion of a bicycle frame in a mounted state where the derailleur hanger is mounted to the bicycle frame, and a frangible part disposed between the first part and the second part. The frangible part is configured to break relative to the first part and the second part upon application of a predetermined force or higher to the pin.

With the derailleur hanger according to the first aspect, it is possible to absorb an impact of external object hitting a derailleur attached to the derailleur hanger by the pin being broken by the impact.

In accordance with a second aspect of the present disclosure, the derailleur hanger according to the first aspect is configured so that the frangible part is disposed at a position between the first surface and the third surface.

With the derailleur hanger according to the second aspect, it is possible to prevent damage to the bicycle frame from the pin after the pin has been broken from an impact.

In accordance with a third aspect of the present disclosure, the derailleur hanger according to the first aspect or the second aspect is configured so that the frangible part is configured to be disposed outside of the pin receiving portion of a bicycle frame in the mounted state.

With the derailleur hanger according to the third aspect, it is possible to prevent damage to the bicycle frame from the pin after the pin has been broken from an impact.

In accordance with a fourth aspect of the present disclosure, the derailleur hanger according to any one of the first aspect to the third aspect is configured so that the frangible part includes a groove.

With the derailleur hanger according to the fourth aspect, the pin can be reliably broken upon the application of a predetermined force or higher to the pin.

In accordance with a fifth aspect of the present disclosure, the derailleur hanger according to the fourth aspect is configured so that the pin includes a first end and a second end. The second end is spaced from the first end in the first direction. A first distance between the groove and the first end is larger than a second distance between the groove and the second end.

With the derailleur hanger according to the fifth aspect, the pin can be reliably secured to the derailleur hanger and dimension of the pin receiving portion of the bicycle frame can be minimized.

In accordance with a sixth aspect of the present disclosure, the derailleur hanger according to the fourth aspect or the fifth aspect is configured so that the pin includes a pin axis extending in the first direction and a circumferential surface extending in a circumferential direction around the pin axis. The groove extends circumferentially on the circumferential surface to define a continuous groove.

With the derailleur hanger according to the sixth aspect, the pin can be reliably broken upon the application of a predetermined force or higher to the pin.

In accordance with a seventh aspect of the present disclosure, the derailleur hanger according to any one of the first aspect to the sixth aspect is configured so that the third surface is offset from the first surface in the second direction, and a pin attachment portion provided on the third surface, and the pin is provided to the pin attachment portion.

With the derailleur hanger according to the seventh aspect, it is possible to prevent damage to the bicycle frame from the pin after a portion of the pin has been broken from an impact.

In accordance with an eighth aspect of the present disclosure, a derailleur hanger is provided that basically comprises a first portion, a second portion, a third portion, a pin attachment portion and a pin. The first portion includes an axle receiving bore configured to receive a hub axle. The second portion includes a derailleur support surface configured to support a derailleur. The third portion is coupled the first portion and the second portion. The third portion includes a first surface facing in a first direction, a second surface facing in a second direction opposite the first direction and a third surface offset from the first surface in the second direction. The pin attachment portion is provided on the third portion. The pin includes a first part provided to the pin attachment portion, and a second part projecting in the first direction from the third portion to be received in a pin receiving portion of a bicycle frame in a mounted state where the hanger is mounted to the bicycle frame.

With the derailleur hanger according to the eighth aspect, it is possible to absorb an impact of external object hitting a derailleur attached to the derailleur hanger by the pin being broken by the impact.

In accordance with a ninth aspect of the present disclosure, the derailleur hanger according to the seventh aspect or the eighth aspect is configured so that the pin attachment portion includes a pin attachment hole, and the first part of the pin is fixed to the pin attachment hole.

With the derailleur hanger according to the ninth aspect, the pin can be easily and reliably fixed to the derailleur hanger.

In accordance with a tenth aspect of the present disclosure, the derailleur hanger according to the ninth aspect is configured so that the third surface surrounds the pin attachment hole.

With the derailleur hanger according to the tenth aspect, the pin can be easily and reliably fixed to the derailleur hanger.

In accordance with an eleventh aspect of the present disclosure, the derailleur hanger according to any one of the seventh aspect to the tenth aspect is configured so that the pin attachment portion has a recess, and the third surface is a bottom surface of the recess.

With the derailleur hanger according to the eleventh aspect, the pin can be easily and reliably fixed to the derailleur hanger using a press-fit process.

In accordance with a twelfth aspect of the present disclosure, the derailleur hanger according to any one of the second aspect to the eleventh aspect is configured so that the second part of the pin has a free end disposed opposite of the third surface with respect to the first surface.

With the derailleur hanger according to the twelfth aspect, the second part of the pin can be easily and reliably provided to the pin receiving portion of the bicycle frame, and the second part of the pin break from the first part of the pin.

In accordance with a thirteenth aspect of the present disclosure, the derailleur hanger according to any one of the second aspect to the twelfth aspect further comprises a first peripheral edge portion disposed between the second surface and the third surface. The first surface and the third surface are interconnected by a connecting surface. The third surface and the first peripheral edge portion define a corner opposite to the second portion.

With the derailleur hanger according to the thirteenth aspect, a recess is provided by the third surface and the recess opens to the first peripheral edge portion of the derailleur hanger.

In accordance with a fourteenth aspect of the present disclosure, the derailleur hanger according to any one of the second aspect to the thirteenth aspect further comprises a second peripheral edge portion disposed between the first surface and the second surface, and the second peripheral edge portion includes an inclined surface adjacent to the second surface of the third portion, the inclined surface being configured to aid in attaching and detaching a hub with respect to the hanger.

With the derailleur hanger according to the fourteenth aspect, the inclined surface aids in attaching and detaching a hub with respect to the derailleur hanger.

In accordance with a fifteenth aspect of the present disclosure, the derailleur hanger according to any one of the second aspect to the fourteenth aspect is configured so that the first portion includes a frame attachment surface. The frame attachment surface is configured to contact with the bicycle frame in the mounted state. The third surface is offset from the frame attachment surface in the second direction.

With the derailleur hanger according to the fifteenth aspect, it is possible to prevent damage to the bicycle frame from the pin after the pin has been broken from an impact.

In accordance with a sixteenth aspect of the present disclosure, the derailleur hanger according to any one of the second aspect to the fifteenth aspect is configured so that the third surface is offset from the derailleur support surface in the second direction.

With the derailleur hanger according to the sixteenth aspect, it is possible to prevent damage to the bicycle frame from the pin after the pin has been broken from an impact.

In accordance with a seventeenth aspect of the present disclosure, the derailleur hanger according to any one of the second aspect to the sixteenth aspect is configured so that the derailleur support surface faces in the first direction. The derailleur support surface and the third surface are non-overlapping as viewed in a direction parallel to an axial direction of the axle receiving bore.

With the derailleur hanger according to the seventeenth aspect, the pin can be provided to the third surface at appropriate distance from the derailleur support surface to ensure the pin can be reliably broken upon the application of a predetermined force or higher to the pin.

In accordance with an eighteenth aspect of the present disclosure, the derailleur hanger according to any one of the first aspect to the seventeenth aspect is configured so that the pin protrudes relative to the first surface and does not protrude from the second surface.

With the derailleur hanger according to the eighteenth aspect, the pin will not interfere with the hub or the derailleur.

In accordance with a nineteenth aspect of the present disclosure, the derailleur hanger according to any one of the first aspect to the nineteenth aspect is configured so that the first portion includes a tubular part that protrudes relative to the first surface around the axle receiving bore, and the tubular part is configured to avoid contact with the bicycle frame in the mounted state.

With the derailleur hanger according to the nineteenth aspect, the derailleur hanger can be more easily manufactured because the tubular part does not contribute an alignment of the through axle.

In accordance with a twentieth aspect of the present disclosure, the derailleur hanger according to any one of the first aspect to the nineteenth aspect further comprises a first chain restriction portion including a first chain restriction surface. The first portion includes a hub contact surface facing the second direction. The first chain restriction surface faces in the second direction and is offset from the second surface in the second direction.

With the derailleur hanger according to the twentieth aspect, it is possible to reliably suppress chain drop from a sprocket of the hub.

In accordance with a twenty-first aspect of the present disclosure, the derailleur hanger according to any one of the first aspect to the twentieth aspect is configured so that the first portion includes a frame attachment surface. The frame attachment surface is configured to contact with the bicycle frame in the mounted state, the frame attachment surface is disposed in a plane extending perpendicular to an axial direction of the axle receiving bore. The derailleur support surface is disposed in the plane.

With the derailleur hanger according to the twenty-first aspect, it is possible to appropriately position the derailleur with respect to the bicycle frame in the mounted state.

Also, other objects, features, aspects and advantages of the disclosed derailleur hanger will become apparent to those skilled in the art from the following detailed description, which, taken in conjunction with the annexed drawings, discloses preferred embodiments of the derailleur hanger.

### BRIEF DESCRIPTION OF THE DRAWINGS

Referring now to the attached drawings which form a part of this original disclosure, illustrative embodiments are shown.

FIG. 1 is a rear perspective view of a rear portion of a vehicle frame having a rear hub mounted to the vehicle frame, a sprocket assembly mounted to the rear hub, and a rear derailleur mounted to the vehicle frame by a derailleur hanger assembly in accordance with a first embodiment.

FIG. 2 is a right side elevational view of the rear portion of the vehicle frame, the rear hub, the rear derailleur and the derailleur hanger assembly illustrated in FIG. 1.

FIG. 3 is a rear elevational view of the rear portion of the vehicle frame, a rear hub axle of the rear hub and the derailleur hanger illustrated in FIGS. 1 and 2.

FIG. 4 is an inside perspective view of a right rear frame portion, and the derailleur hanger assembly illustrated in FIGS. 1 to 3.

FIG. 5 is an outside perspective view of a right rear frame portion, and the derailleur hanger assembly illustrated in FIGS. 1 to 4.

FIG. 6 is an inside elevational view of the right rear portion of the vehicle frame and the derailleur hanger assembly illustrated in FIGS. 1 to 5.

FIG. 7 is an outside elevational view of the right rear portion of the vehicle frame, and the derailleur hanger assembly illustrated in FIGS. 1 to 6.

FIG. 8 is an inside elevational view of the right rear portion of the vehicle frame and the derailleur hanger illustrated in FIGS. 1 to 7 in which the derailleur hanger has been deflected causing the pin to break and the derailleur hanger to move relative to the vehicle frame.

FIG. 9 is a cross sectional view of the right rear portion of the vehicle frame and the derailleur hanger assembly illustrated in FIGS. 1 to 8 as seen along section line 9-9 of FIG. 6.

FIG. 10 is an enlarged cross sectional view of the right rear portion of the vehicle frame and the derailleur hanger assembly illustrated in FIG. 9.

FIG. 11 is an exploded outside perspective view of the right rear frame portion, and the derailleur hanger assembly illustrated in FIGS. 1 to 10.

FIG. 12 is an exploded inside perspective view of the right rear frame portion and the derailleur hanger assembly illustrated in FIGS. 1 to 11.

FIG. 13 is a first perspective view of the derailleur hanger of the derailleur hanger assembly illustrated in FIGS. 1 to 12.

FIG. 14 is a second perspective view of the derailleur hanger illustrated in FIG. 13.

FIG. 15 is a first side elevational view of the derailleur hanger illustrated in FIGS. 13 and 14.

FIG. 16 is a second side elevational view of the derailleur hanger illustrated in FIGS. 13 to 15.

FIG. 17 is a front edge elevational view of the derailleur hanger illustrated in FIGS. 13 to 16.

FIG. 18 is a rear edge elevational view of the derailleur hanger illustrated in FIGS. 13 to 17.

FIG. 19 is a top edge view of the derailleur hanger illustrated in FIGS. 13 to 18.

FIG. 20 is a bottom edge view of the derailleur hanger illustrated in FIGS. 13 to 19.

FIG. 21 is a cross sectional view of a right rear portion of a vehicle frame and a derailleur hanger assembly in accordance with a first modification.

FIG. 22 is a first perspective view of a derailleur hanger assembly in accordance with a second modification.

FIG. 23 is a second perspective view of the derailleur hanger illustrated in FIG. 22.

FIG. 24 is an inside perspective view of a right rear frame portion, and a derailleur hanger assembly mounted to the right rear frame portion in accordance with a third modification.

FIG. 25 is an outside perspective view of the right rear frame portion, and the derailleur hanger assembly illustrated in FIG. 24.

FIG. 26 is an outside elevational view of the right rear portion of the vehicle frame, and the derailleur hanger assembly illustrated in FIGS. 24 and 25.

FIG. 27 is an exploded inside perspective view of the right rear frame portion and the derailleur hanger assembly illustrated in FIGS. 23 to 25.

FIG. 28 is a first cross sectional view of the right rear portion of the vehicle frame and the derailleur hanger assembly illustrated in FIGS. 24 to 27 as seen along section line 28-28 of FIG. 26.

FIG. 29 is a second cross sectional view of the right rear portion of the vehicle frame and the derailleur hanger assembly illustrated in FIGS. 23 to 27 as seen along section line 29-29 of FIG. 26.

### DETAILED DESCRIPTION

Selected embodiments will now be explained with reference to the drawings. It will be apparent to those skilled in the bicycle field from this disclosure that the following descriptions of the embodiments are provided for illustration only and not for the purpose of limiting the invention as defined by the appended claims and their equivalents.

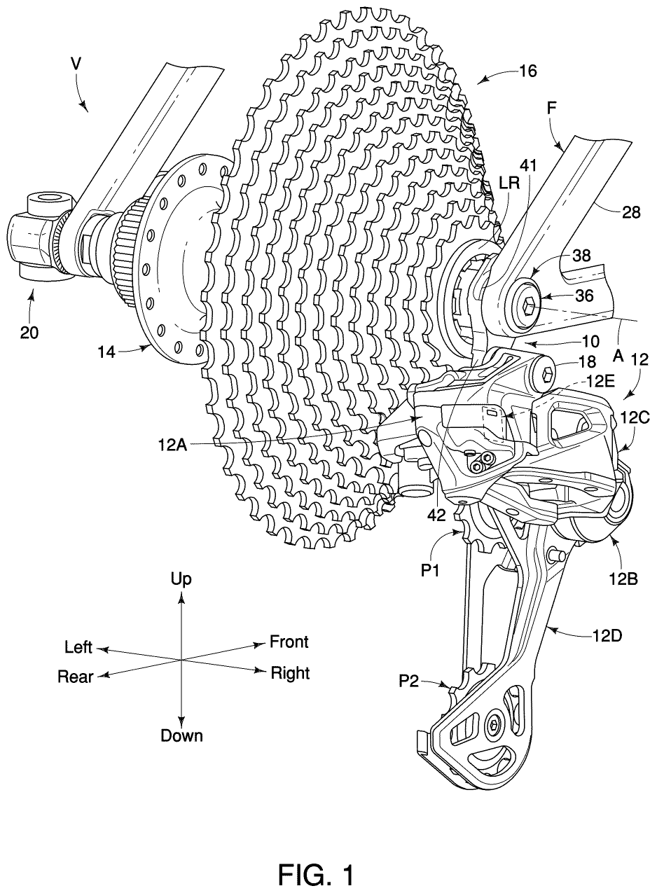

Referring initially to FIGS. 1 to 3, a rear portion of a bicycle V is illustrated that is equipped with a derailleur hanger assembly 10 in accordance with a first embodiment. The bicycle V includes, among other things, a derailleur 12, a rear hub 14 and a rear sprocket assembly 16. In particular, the rear derailleur 12 is mounted to a bicycle frame F of the bicycle V by a derailleur hanger assembly 10 in accordance with a first embodiment. Since bicycles are well known in the bicycle field, the human-powered bicycle V will not be discussed or illustrated in detail herein, except for the portions of the bicycle frame F that relate to the derailleur hanger assembly 10.

As seen in FIG. 1, the bicycle V has a vehicle center plane CP vertically bisecting the bicycle frame F of the bicycle V in a longitudinal direction (a front to rear direction). The vehicle center plane CP passes through a center of the bicycle frame F in a width direction (a left to right direction) of the bicycle frame F. Thus, the vehicle center plane CP separates a left side of the bicycle V from a right side of the bicycle V. The following directional terms “front,” “rear,” “forward,” “rearward,” “left,” “right,” “lateral,” “longitudinal”, “upward,” and “downward,” as well as any other similar directional terms, refer to those directions which are determined on the basis of a rider sitting upright on a seat of the bicycle V while facing a handlebar of the bicycle V.

In the first embodiment, the derailleur 12 is a bicycle rear derailleur that is typically used with a mountain bike. Of course, it will be apparent from this disclosure that the derailleur hanger assembly 10 can be used with other types of derailleurs. Since derailleurs are well known in the bicycle field, the derailleur 12 will not be discussed or illustrated in detail herein, except for as the derailleur 12 relates to the derailleur hanger assembly 10.

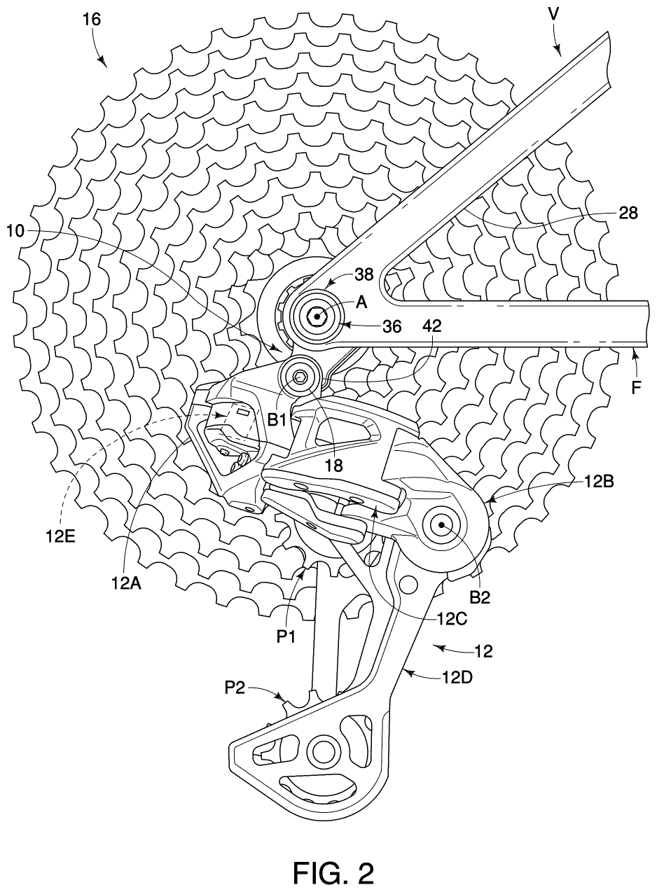

As seen in FIGS. 1 and 2, the derailleur 12 basically comprises a base member 12A, a movable member 12B, a linkage 12C and a chain guide 12D. Here, the derailleur 12 is an electric derailleur having a motor unit 12E. The base member 12A is mounted to the derailleur hanger assembly 10 by a fixing bolt 18. In this way, the base member 12A is configured to be attached to the bicycle frame F of the bicycle V by the derailleur hanger assembly 10. Preferably, the base member 12A is configured to pivot relative to the bicycle frame F about a pivot axis B1, which is defined by the fixing bolt 18. The linkage 12C movably couples the movable member 12B to the base member 12A. The movable member 12B is movably coupled to the base member 12A by the linkage 12C. The chain guide 12D is pivotally coupled to the movable member 12B about a pivot axis B2. Preferably, the chain guide 12D includes at least one pulley. Here, the chain guide 12D includes a first pulley P1 and a second pulley P2. The motor unit 12E is mounted to the base member 12A. The motor unit 12E has a reversible electric motor that is operatively coupled to the linkage 12C for moving the linkage 12C such that the movable member 12B is moved relative to the base member 12A. The electric motor of the motor unit 12E is disposed inside a housing that is mounted to the base member 12A.

Basically, the derailleur 12 is configured to move a chain from one sprocket of the rear sprocket assembly 16 to an adjacent sprocket of the rear sprocket assembly 16 in response to either an automatic shift signal from a cycle computer, or a shift signal inputted by a user from an operating device. Here, the derailleur 12 is mounted to the right side of the rear portion of the bicycle frame F by the derailleur hanger assembly 10. The derailleur hanger assembly 10 is configured to support the derailleur 12 to the rear portion of the bicycle frame F such that the derailleur 12 is positioned farther to the right of the center plane CP as compared to a derailleur mounted to a vehicle frame using a conventional derailleur hanger. Thus, the derailleur hanger assembly 10 is particularly useful for supporting a derailleur when a rear sprocket assembly is provided with a large number of sprockets such as thirteen sprockets in the case of the rear sprocket assembly 16.

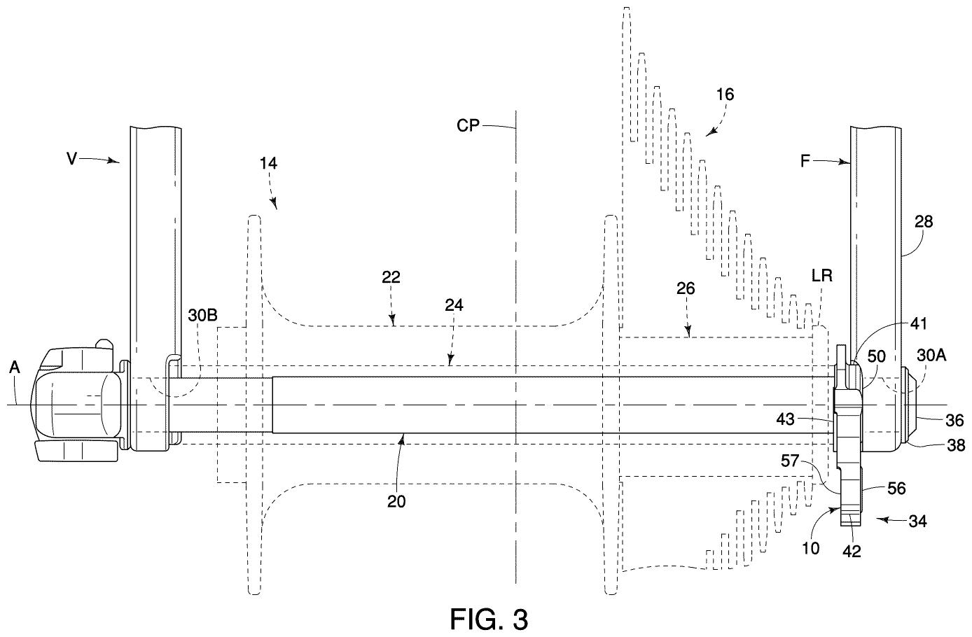

As seen in FIG. 3, the rear hub 14 is mounted to the bicycle frame F of the bicycle V by a thru-axle 20. The rear hub 14 includes a hub body 22, a hub axle 24 and a freewheel body 26. The hub axle 24 has a center axis A. The center axis A corresponds a center axis of the thru-axle 20. The center axis A also corresponds to an axis of rotation of the hub body 22 and the freewheel body 26. The hub body 22 and the freewheel body 26 are rotatably mounted on the hub axle 24 by bearings in a conventional manner to rotate about the center axis A. The hub axle 24 is a hollow tube for receiving the thru-axle 20. The thru-axle 20 extends through hub axle 24, and is coupled to a rear portion 28 of the bicycle frame F. In particular, the rear portion 28 of the bicycle frame F has a right mounting opening 30A and a left mounting opening 30B for receiving the thru-axle 20. When the thru-axle 20 is installed to the rear portion 28 of the bicycle frame F, the hub axle 24 and the thru-axle 20 are non-rotatable secured to the rear portion 28 of the bicycle frame F. Thus, the hub axle 24 and the thru-axle 20 can also be jointly referred to as the hub axle of the rear hub 14. The rear portion 28 of the bicycle frame F further includes a pin receiving portion 32 (FIG. 9). Here, the pin receiving portion 32 is a blind bore that is spaced radially from the right mounting opening 30A. Alternatively, the pin receiving portion 32 can be a through bore. The rear portion 28 of the bicycle frame F further includes a restricting member 33. Here, the restricting member 33 is a projection that is spaced radially from the right mounting opening 30A. The functions of the pin receiving portion 32 and the restricting member 33 will be described below.

The rear sprocket assembly 16 is retained on the freewheel body 26 by a locking ring LR. The rear sprocket assembly 16 is non-rotatably mounted to the freewheel body 26 so that the rear sprocket assembly 16 and the freewheel body 26 rotate together. The freewheel body 26 is connected to the hub body 22 via one-way clutch. In this way, a torque is transmitted from the rear sprocket assembly 16 to the hub body 22, in a state where the rear sprocket assembly 16 is rotated by a pedaling action or a drive unit in a forward driving direction. On the other hand, the hub body 22 can rotate in a forward driving direction relative to the freewheel body 26 and the rear sprocket assembly 16 in a state where the rear sprocket assembly 16 is stopped or rotated in a non-driving direction (i.e., opposite the forward driving direction). In the first embodiment, the rear hub 14 is a bicycle rear hub. Rear hubs such as the rear hub 14 are well known in the bicycle field, and thus, the rear hub 14 will not be discussed in further detail herein.

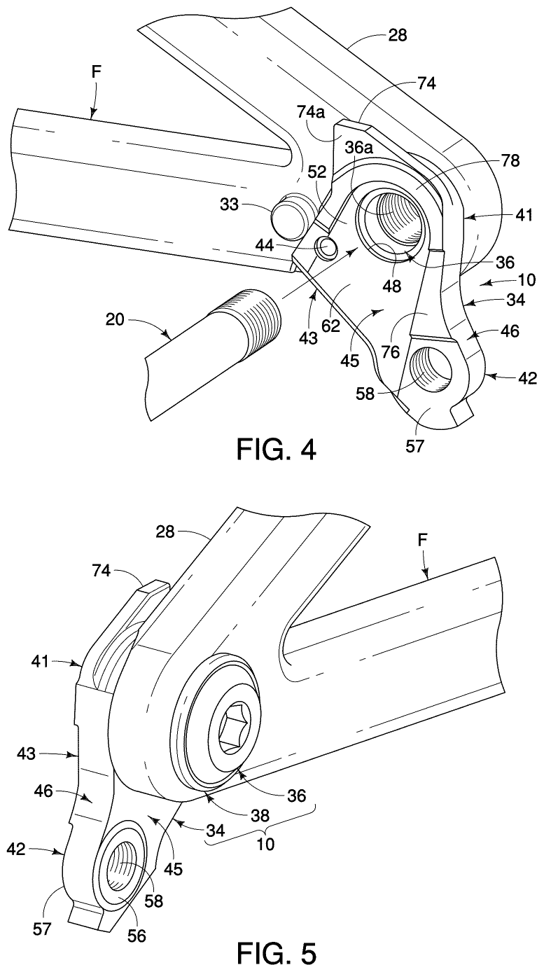

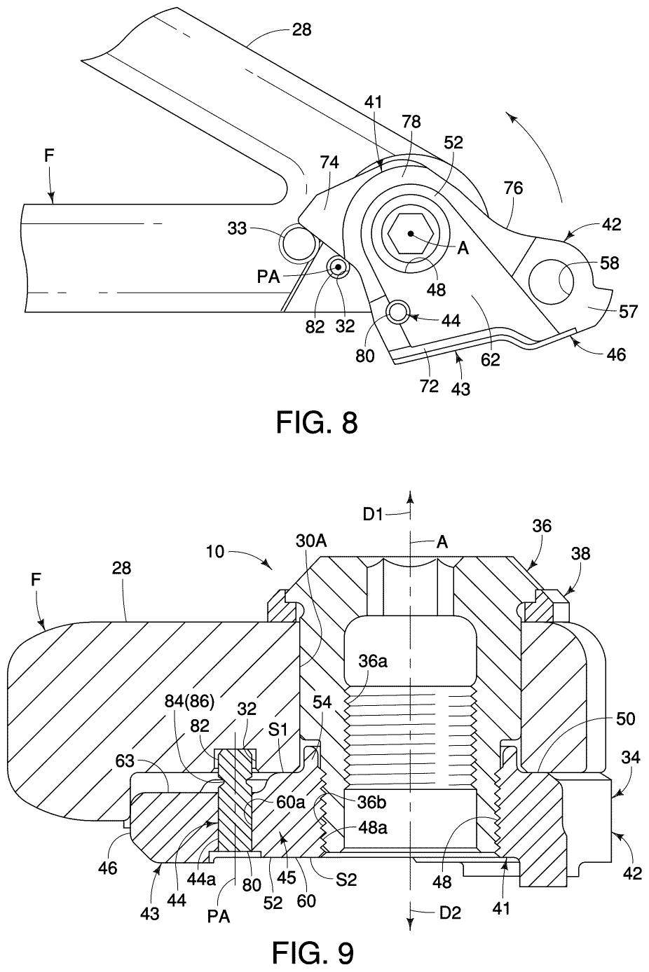

Referring now to FIGS. 4 to 12, the derailleur hanger assembly 10 will now be discussed in more detail. Basically, the derailleur hanger assembly 10 includes a derailleur hanger 34 and a hanger bolt 36. The derailleur hanger 34 is configured to be axially spaced from the locking ring LR with respect to the center axis A. In the words, a gap exists between the locking ring LR and the derailleur hanger 34 so that the locking ring LR does not contact the derailleur hanger 34. Here, the derailleur hanger assembly 10 further includes a hanger washer 38. The hanger washer 38 is preferably made of a metallic material such as stainless steel. The derailleur hanger 34 is a separate part from the rear portion 28 of the bicycle frame F. Specifically, in the first embodiment, the derailleur hanger 34 is fixed to the rear portion 28 of the bicycle frame F by the hanger bolt 36. The derailleur hanger 34 is in an installed state where the derailleur hanger 34 is mounted to the rear portion 28 of the bicycle frame F.

The hanger bolt 36 is preferably made of a metallic material such as aluminum, stainless steel, or the like. The hanger bolt 36 includes an internal thread 36a for threadedly receiving the thru-axle 20 to attach the rear hub 14 to the bicycle frame F in a conventional manner. The internal thread 36a is a preferably a right-hand thread. The hanger bolt 36 further includes an external thread 36b for attaching the derailleur hanger 34 to the rear portion 28 of the bicycle frame F. The external thread 36b is a preferably a left-hand thread. In the installed state of the derailleur hanger 34, a head portion of the hanger bolt 36 contacts and a shaft portion of the hanger bolt 36 is threadedly attached to the derailleur hanger 34. With the derailleur hanger 34 in the installed state, the thru-axle 20 is threadedly attached to the hanger bolt 36 for attaching the rear hub 14 to the bicycle frame F.

As seen in FIGS. 4 and 5, the derailleur hanger 34 comprises a first portion 41, a second portion 42, a third portion 43 and a pin 44. The third portion 43 is coupled the first portion 41 and the second portion 42. In the first embodiment, the first portion 41, the second portion 42 and the third portion 43 are formed as a one-piece member of a suitable material. The first portion 41, the second portion 42 and the third portion 43 can also be referred to as a main body 45 of the derailleur hanger 34. For example, the first portion 41, the second portion 42 and the third portion 43 is formed of a hard rigid material such as a metal alloy, or a fiber reinforced plastic (e.g., plastic reinforced with carbon fibers or glass fibers). The derailleur hanger 34 further comprises a peripheral edge 46. The peripheral edge 46 forms the periphery of the main body 45.

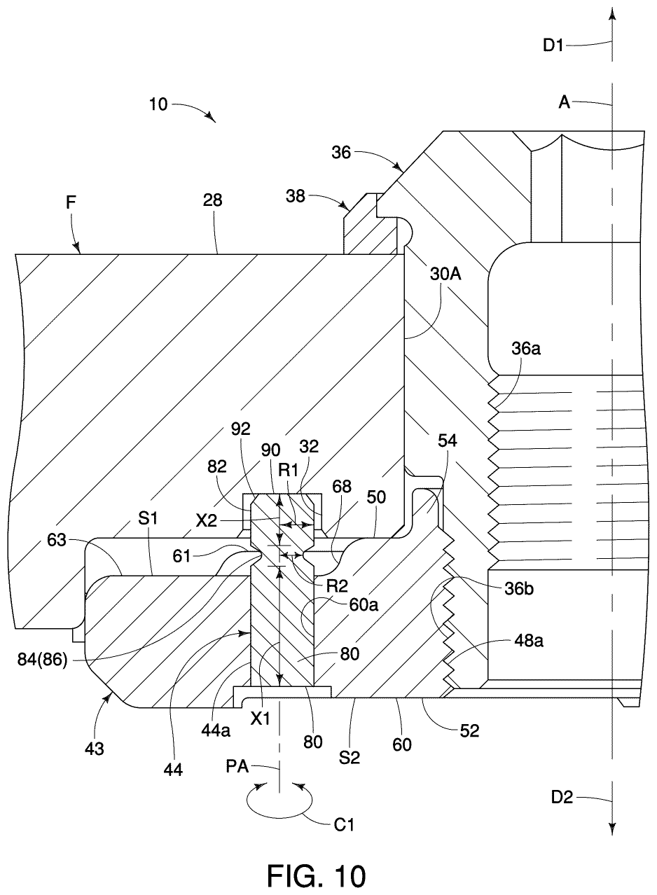

In the first embodiment, as seen in FIGS. 9 and 10, the the pin 44 is a separate member from the main body 45 (e.g., the first portion 41, the second portion 42 and the third portion 43). In particular, the pin 44 is a separate member that is fixed to the third portion 43. The main body 45 has a first side S1 that faces a first direction D1 in the mounted state, and a second side S2 that faces a second direction D2 opposite the first direction D1. Here, the pin 44 protrudes from the first side S1 of the main body 45 in the first direction D1, and is partly received in the pin receiving portion 32 of the bicycle frame F.

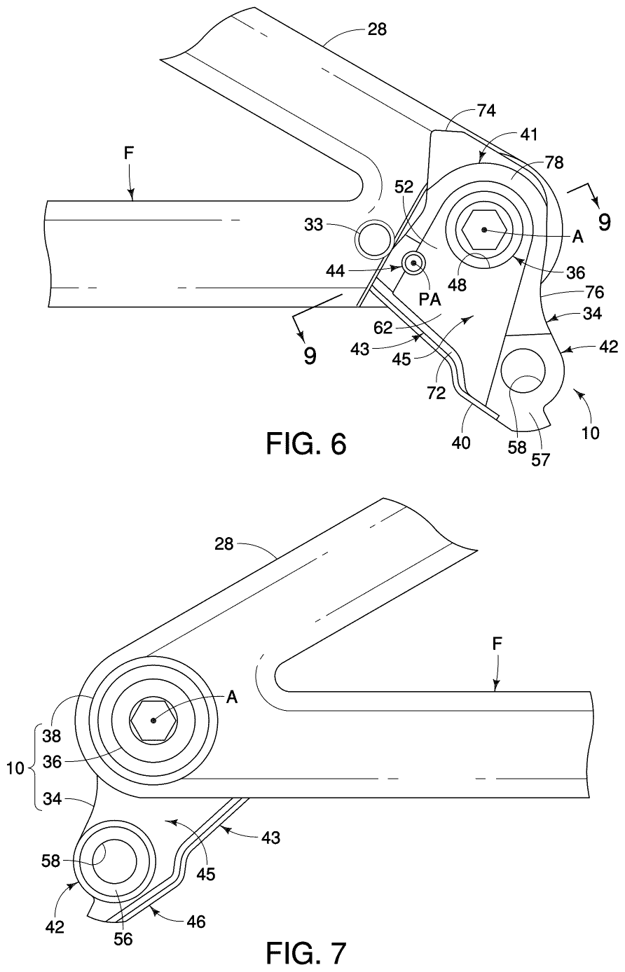

As seen in FIGS. 4 and 6, the pin 44 prevents the derailleur hanger 34 from pivoting relative to the bicycle frame F about the center axis A of the hub axle 24 in the installed state. However, the pin 44 is configured to break upon application of a predetermined force (e.g., a torque about the center axis A) or higher to the pin 44. When the pin 44 has broken due to the application of a predetermined force or higher to the pin 44 in a rearward direction, the derailleur hanger 34 can pivot rearwardly relative to the bicycle frame F until the derailleur hanger 34 contacts the restricting member 33. On the other hand, after the pin 44 breaks, the restricting member 33 contacts the derailleur hanger 34 to prevent forward movement of relative to the bicycle frame F about the center axis A. Moreover, the restricting member 33 is configured to restrict rearward movement of the derailleur hanger 34 about the center axis A of the hub axle 24 after the pin 44 breaks. The restricting member 33 is also configured to contact the derailleur hanger 34 prior to the pin 44 breaking to prevent forward movement of relative to the bicycle frame F. In this way, the pin 44 is protected from breaking upon a force being applied to the derailleur hanger 234 in a forward direction relative to the bicycle frame F. Of course, when the pin 44 is broken, the restricting member 33 limits the range movement of the derailleur hanger 234 about the center axis A of the hub axle 24 within a predetermined range.

Preferably, the material of the pin 44 is different from the material of the main body 45 of the derailleur hanger 34. For example, the main body 45 of the derailleur hanger 34 is made of a first metallic material (e.g., aluminum) and the pin 44 is made of a second metallic material (e.g., stainless steel). Alternatively, the main body 45 and the pin 44 can be made of the same metallic material as needed and/or desired. Alternatively, the main body 45 of the derailleur hanger 34 is made of a metallic material (e.g., aluminum) and the pin 44 is made of a non-metallic material (e.g., plastic). In any case, the pin 44 is configured to break at a target torque as described below.

Referring back to FIG. 3, the first portion 41 is configured to be mounted to the hub axle 24. In the first embodiment, the first portion 41 is mounted to the hub axle 24 via the thru-axle 20. Specifically, as seen in FIGS. 4, 11 and 12, the first portion 41 includes an axle receiving bore 48. The axle receiving bore 48 is configured to receive the hub axle 24. More specifically, the axle receiving bore 48 is configured to threadedly receive the hanger bolt 36, which in turn is configured to threadedly receive the thru-axle 20 for mounting the hub axle 24 to the first portion 41.

As seen in FIGS. 9 and 10, the first portion 41 is sandwiched between an inner facing surface of the rear portion 28 of the bicycle frame F and an end surface of the hub axle 24 and in the installed state. In other words, in the installed state, the first portion 41 is configured to contact the inner facing surface of the rear portion 28 of the bicycle frame F, and the first portion 41 is configured to contact an end surface of the hub axle 24. In particular, the first portion 41 further includes a frame attachment surface 50. The first portion 41 further includes a hub contact surface 52. The frame attachment surface 50 faces the first direction D1 in the mounted state. The hub contact surface 52 faces the second direction D2 in the mounted state. Thus, the hub contact surface 52 faces in the opposite direction from the frame attachment surface 50 in the mounted state. The frame attachment surface 50 is configured to contact with the bicycle frame F in the mounted state. More specifically, the frame attachment surface 50 contacts the inner facing surface of the rear portion 28 of the bicycle frame F of the bicycle frame F. Thus, the frame attachment surface 50 can also be referred to as a frame contact surface. The frame attachment surface 50 is held in contact with the inner facing surface of the rear portion 28 by the hanger bolt 36, which is attached to the thru-axle 20. The frame attachment surface 50 is disposed in a plane P1 extending perpendicular to an axial direction of the axle receiving bore 48. The hub contact surface 52 is configured to contact the rear hub 14 in the mounted state. More specifically, the hub contact surface 52 is configured to contact the end surface of the hub axle 24 in the mounted state.

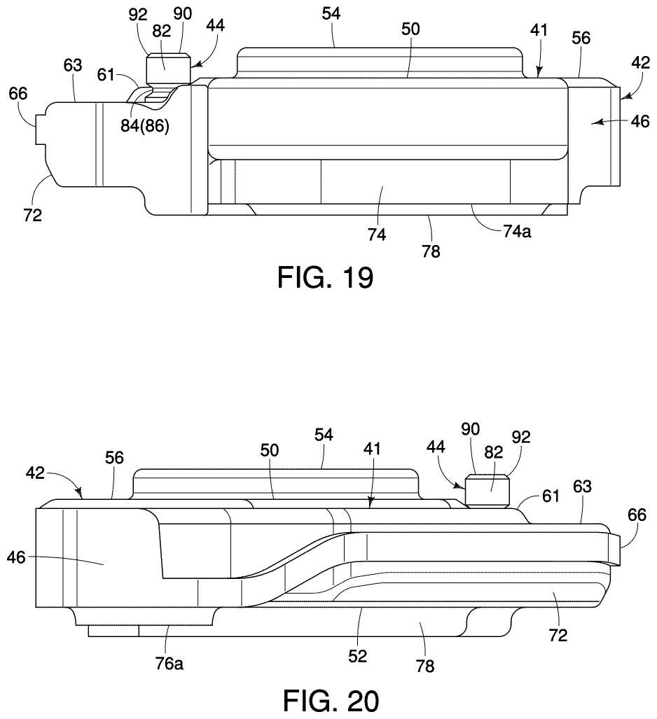

As seen in FIGS. 9, 11, 13 and 17 to 20, the first portion 41 further includes a tubular part 54. The tubular part 54 is positioned in the mounting opening 30A in the mounted state. Here, the tubular part 54 is configured to avoid contact with the bicycle frame F in the mounted state. In other words, a gap exists between the tubular part 54 and the surface that defines the mounting opening 30A as seen in FIG. 9. As a result, the thru-axle 20 is aligned with the bicycle frame F only by the hanger bolt 36. In other words, the derailleur hanger 34 does not contribute the alignment and the positioning of the thru-axle 20 to the bicycle frame F.

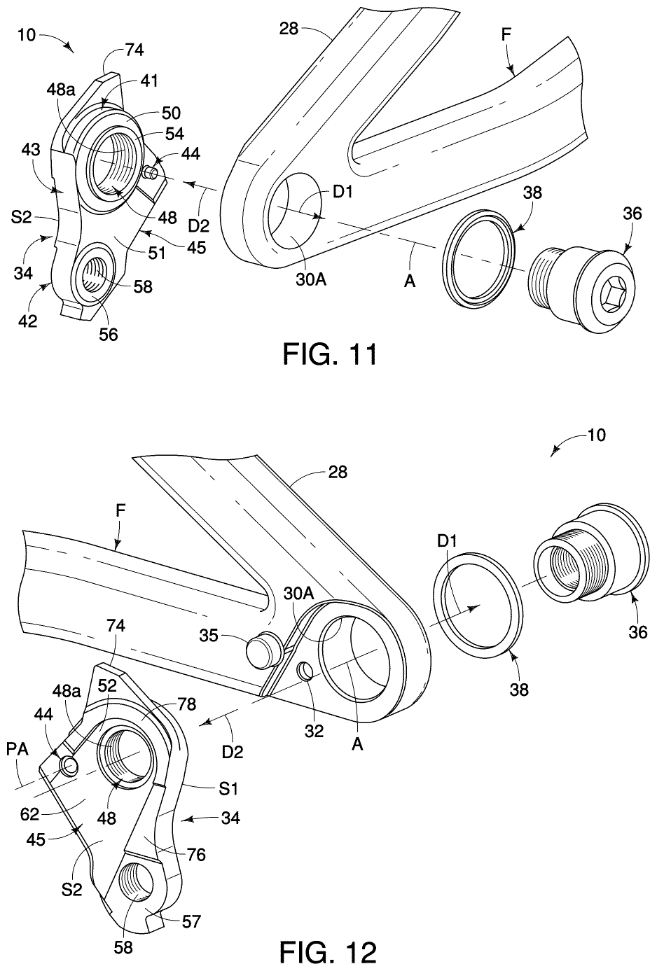

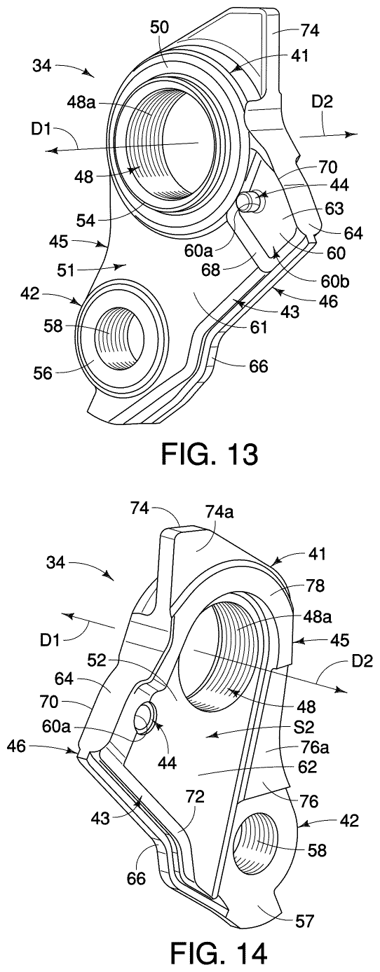

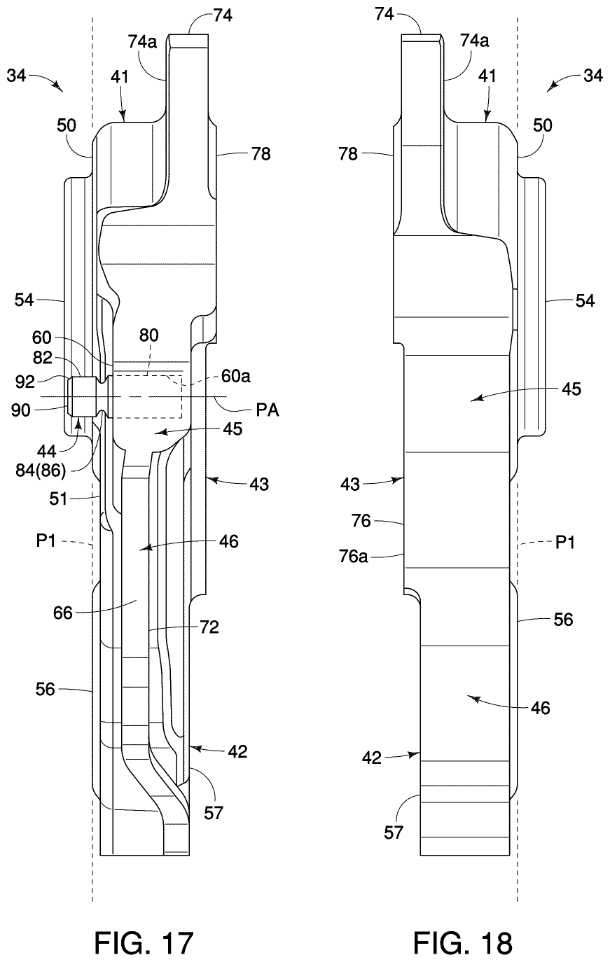

Referring back to FIGS. 1 and 2, the second portion 42 is configured to support the derailleur 12. More specifically, the second portion 42 includes a derailleur support surface 56 configured to support the derailleur 12. In particular, the derailleur 12 contacts the derailleur support surface 56 in the first embodiment. The second portion 42 also includes an additional derailleur support surface 57 that faces in the opposite direction to the derailleur support surface 56. In the case where the derailleur has a mounting portion that sandwiches the second portion 42, the mounting portion of the derailleur can contact both the derailleur support surface 56 and the additional derailleur support surface 57. Also, the second portion 42 includes a fixing bolt receiving bore 58. Here, in the first embodiment, the fixing bolt receiving bore 58 includes an internal thread that threadedly receives the fixing bolt 18 of the derailleur 12. Alternatively, the fixing bolt receiving bore 58 can be unthreaded and the derailleur 12 can be attached to the second portion 42 using a bolt and a nut. As seen in FIGS. 11 and 13, the derailleur support surface 56 faces in the first direction D1 in the mounted state. As seen in FIGS. 17 and 18, the derailleur support surface 56 is disposed in the plane P1.

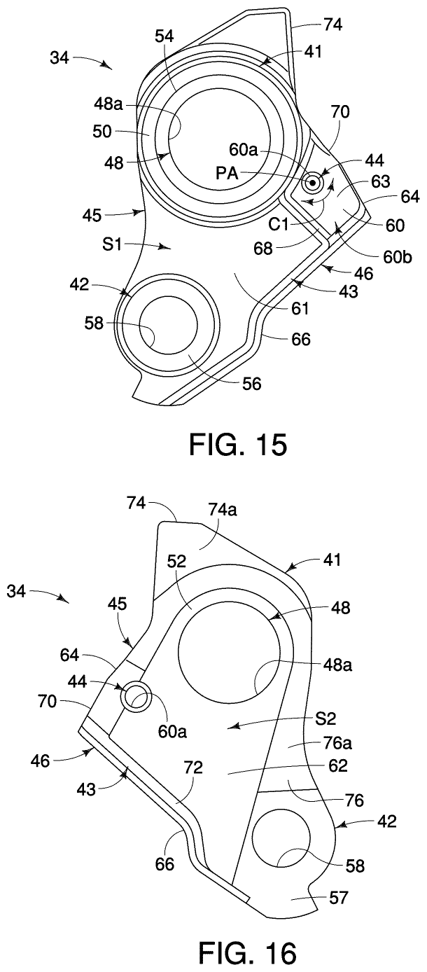

As seen in FIGS. 13 and 15, the derailleur hanger 34 further comprises a pin attachment portion 60. Here, in the first embodiment, the third portion 43 includes the pin attachment portion 60. In particular, the pin attachment portion 60 is provided on the third surface 63. The pin 44 is provided to the pin attachment portion 60. Here, in the first embodiment, the pin attachment portion 60 includes a pin attachment hole 60a. The pin 44 is fixed in the pin attachment hole 60a as described below. Preferably, the third surface 63 surrounds the pin attachment hole 60a. The pin attachment portion 60 has a recess 60b. The third surface 63 is a bottom surface of the recess 60b.

In the first embodiment, as seen in FIGS. 13 to 20, the third portion 43 includes a first surface 61, a second surface 62 and a third surface 63. The first surface 61 faces in the first direction D1. The second surface 62 faces in the second direction D2 opposite the first direction D1. The third surface 63 faces in the first direction D1. The third surface 63 is offset from the first surface 61 in the second direction D2. Also, here, the third surface 63 is offset from the frame attachment surface 50 in the second direction D2. In particular, the third surface 63 is axially offset from the frame attachment surface 50 with respect to the axle receiving bore 48. Moreover, the third surface 63 is offset from the derailleur support surface 56 in the second direction D2. Further, the derailleur support surface 56 and the third surface 63 are non-overlapping as viewed in a direction parallel to an axial direction of the axle receiving bore 48.

Referring to FIGS. 9 and 11, the tubular part 54 protrudes relative to the first surface 61 around the axle receiving bore 48. In this way, the axle receiving bore 48 is disposed in the mounting opening 30A of the bicycle frame F in the mounted state. Here, the frame attachment surface 50 encircles the tubular part 54 so that the frame attachment surface 50 contacts the bicycle frame F.

Referring to FIGS. 13 to 20, the derailleur hanger 34 further comprises a first peripheral edge portion 64. The derailleur hanger 34 further comprises a second peripheral edge portion 66. The first peripheral edge portion 64 and the second peripheral edge portion 66 are individual sections of the peripheral edge 46. The first peripheral edge portion 64 is disposed between the second surface 62 and the third surface 63. The first surface 61 and the third surface 63 are interconnected by a connecting surface 68. The third surface 63 and the first peripheral edge portion 64 define a corner 70 opposite to the second portion 42.

As best seen in FIG. 14, the second peripheral edge portion 66 is disposed between the first surface 61 and the second surface 62. The second peripheral edge portion 66 includes an inclined surface 72. The inclined surface 72 is adjacent to the second surface 62 of the third portion 43. The inclined surface 72 is configured to aid in attaching and detaching a hub with respect to the hanger 34.

Referring now to FIGS. 14 and 16, the derailleur hanger 34 further comprises a first chain restriction portion 74 including a first chain restriction surface 74a. The first chain restriction surface 74a faces in the second direction D2 and is offset from the second surface 62 in the second direction D2. Optionally, the derailleur hanger 34 can include other chain restriction structures for preventing a chain from jamming between the first portion 41 of the derailleur hanger 34 and the smallest sprocket of the rear sprocket assembly 16. For example, here, the derailleur hanger 34 further comprises a second chain restriction portion 76 including a second chain restriction surface 76a. The second chain restriction surface 76a faces in the second direction D2 and is offset from the second surface 62 in the second direction D2. Here, the second chain restriction surface 76a lies in the same plane as the first chain restriction surface 74a, The first chain restriction portion 74 and the second chain restriction portion 76 cooperate to aid in preventing a chain from jamming between the first portion 41 of the derailleur hanger 34 and the smallest sprocket of the rear sprocket assembly 16.

As seen in FIGS. 12 and 14, the derailleur hanger 34 further comprises includes a collar 78. The collar 78 protrudes from the hub contact surface 52 in a direction parallel to the center axis A toward the vehicle center plane CP. The collar 78 has a U-shape as viewed in a direction parallel to the center axis A. The collar 78 is dimensioned to partially surround the hub axle 24 in the installed state. The collar 78 aids in preventing a chain from jamming between the first portion 41 of the derailleur hanger 34 and the smallest sprocket of the rear sprocket assembly 16. In other words, the collar 78 constitutes a diverting region on which a chain can slip transversely with respect to a longitudinal direction of the chain.

Referring now to mainly FIGS. 9 and 10, the pin 44 basically includes a first part 80 and a second part 82. In the first embodiment, the first part 80 and the second part 82 are cylindrical. Alternatively, the first part 80 can be stepped so that the first part 80 includes a head or flange portion and a shaft portion. However, preferably, the first part 80 does not include a head or flange portion, because a length of the press-fit can be longer without a head or flange portion. As a result, the pin 44 can be reliably fixed to the derailleur hanger 34.

The first part 80 is coupled to the third portion 43. Specifically, the first part 80 is provided to the pin attachment portion 60. More specifically, the first part 80 of the pin 44 is fixed to the pin attachment hole 60a. Here, for example, the first part 80 of the pin 44 is press-fitted into the pin attachment hole 60a. In the first embodiment, the process of press-fitting the pin 44 into the pin attachment hole 60a is aided by the third surface 63 surrounding the pin attachment hole 60a. In particular, the third surface 63 is provided surround the pin attachment hole 60a so that the jig can reliably support the derailleur hanger 34 during the press-fit process. In this way, the pin 44 can be reliably and firmly fixed to the derailleur hanger 34. Alternatively, the first part 80 of the pin 44 can be retained in the pin attachment hole 60a by bonding. The pin 44 protrudes relative to the first surface 61 and does not protrude from the second surface 62. The second part 82 projects in the first direction D1 from the third surface 63 to be received in the pin receiving portion 32 of the bicycle frame F in a mounted state where the derailleur hanger 34 is mounted to the bicycle frame F. In this way, the pin 44 prevents movement of the derailleur hanger 34 relative to the bicycle frame F about the center axis A.

Here, the pin 44 further includes a frangible part 84. Here, the frangible part 84 includes a groove 86. The frangible part 84 is disposed between the first part 80 and the second part 82. The frangible part 84 is configured to break relative to the first part 80 and the second part 82 upon application of a predetermined force or higher to the pin 44. For example, the predetermined force at which the frangible part 84 breaks can be set to a torque of 1.5 times or more than the friction torque applied by the hanger bolt 36. Preferably, the frangible part 84 is disposed at a position between the first surface 61 and the third surface 63. More preferably, the frangible part 84 is configured to be disposed outside of the pin receiving portion 32 of the bicycle frame F in the mounted state. In the first embodiment, as seen in FIG. 10, the first part 80 and the second part 82 of the pin 44 each has a first radius R1 and the frangible part 84 has a second radius R2. The first radius R1 is larger than the second radius R2. Preferably, as illustrated, the second radius R2 is more than half of the first radius R1.

In the case where the pin 44 breaks along the frangible part 84 from an impact to the derailleur hanger 34, the second part 82 of the pin 44 is broken off and can be received in the space between the third surface 63 and the bicycle frame F during rotation of the derailleur hanger 34 while absorbing the impact. Alternatively, in the case where the pin 44 breaks along the frangible part 84 from an impact to the derailleur hanger 34, the second part 82 of the pin 44 that is broken off can be removed or ejected out of the space the third surface 63 and the bicycle frame F during rotation of the derailleur hanger 34 while absorbing the impact. Therefore, damage occurring to the bicycle frame F from the second part 82 being broken off and being sandwiched between the derailleur hanger 34 and the bicycle frame F can be suppressed.

In the first embodiment, the pin 44 includes a pin axis PA extending in the first direction D1 and a circumferential surface 44a extending in a circumferential direction C1 around the pin axis PA as illustrated in FIG. 10. The groove 86 extends circumferentially on the circumferential surface 44a to define a continuous groove. Here, the groove 86 has a V-shape. Alternatively, the groove 86 can be discontinuous and/or can have another shape.

Basically, the pin 44 includes a first end 88 and a second end 90. The second end 90 is spaced from the first end 88 in the first direction D1. A first distance X1 between the groove 86 and the first end 88 is larger than a second distance X2 between the groove 86 and the second end 90. The second part 82 of the pin 44 has the free end 90. The free end 90 is disposed opposite of the third surface 63 with respect to the first surface 61. Here, the free end 90 of the pin 44 has a chamfer 92.

Referring now to FIG. 21, a derailleur hanger assembly 110 is illustrated in accordance with a first modification. Basically, the derailleur hanger assembly 110 comprises a derailleur hanger 134, a hanger bolt 136 and a hanger washer 138. The derailleur hanger 134 is identical to the derailleur hanger 34 of the first embodiment. Thus, the derailleur hanger 134 is provided with a pin 144 to prevent rotation of the derailleur hanger 134 relative to the frame until a predetermined force is applied to the derailleur hanger 134 causing the pin 144 to break. Also, the hanger bolt 136 is identical to the hanger bolt 36 of the first embodiment. In this modification, the frame has a mounting opening 130 that is larger than in diameter than the mounting opening 30A. Here, the derailleur hanger assembly 110 further comprises a sleeve 139 that is positioned in the mounting opening 130 and that receives the hanger bolt 136. The sleeve 139 is preferably made of a plastic material, while the hanger washer 138 is made of a metallic material such as stainless steel. Also, preferably, the sleeve 139 is molded onto the washer 138 so that the washer 138 and the sleeve 139 are integrated together. The sleeve 139 can help with alignment of the hanger bolt 136.to the bicycle frame F.

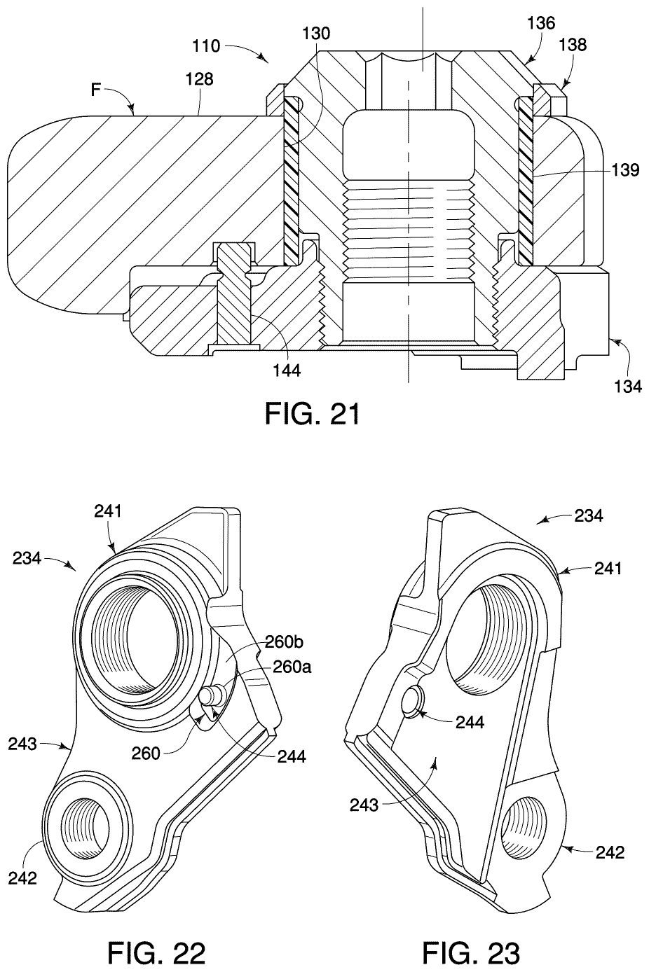

Referring now to FIGS. 22 and 23, a derailleur hanger 234 is illustrated in accordance with a second modification. Here, the derailleur hanger 234 can be used with either the derailleur hanger assembly 10 or the derailleur hanger assembly 110. Similar to the first embodiment, the derailleur hanger 234 comprises a first portion 241, a second portion 242, a third portion 243 and a pin 244. The derailleur hanger 234 is identical to the derailleur hanger 34 of the first embodiment, except that the third portion 243 has been modified. Specifically, the third portion 243 includes a pin attachment portion 260 having a pin attachment hole 260a and a recess 260b where the recess 260b is arc shaped.

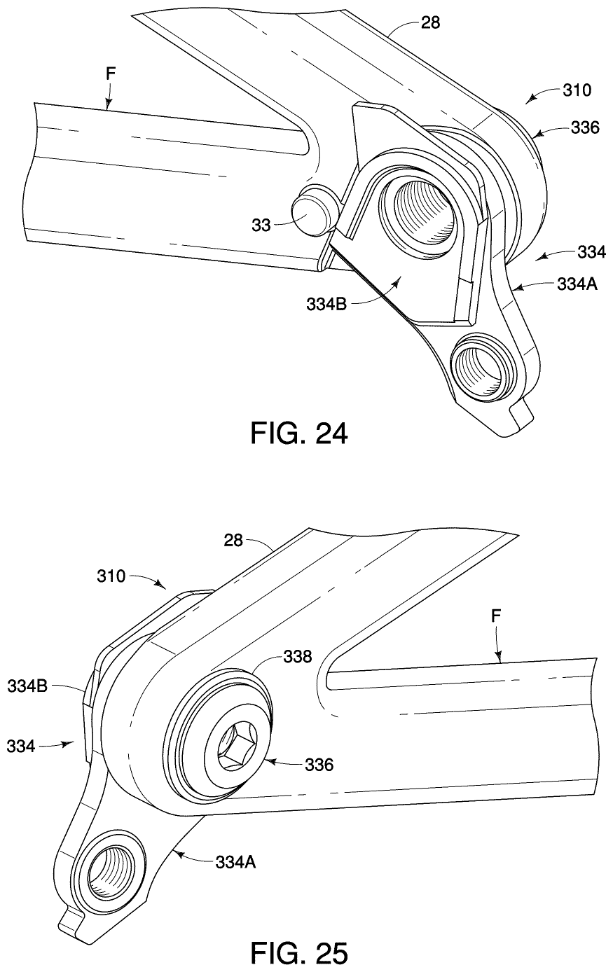

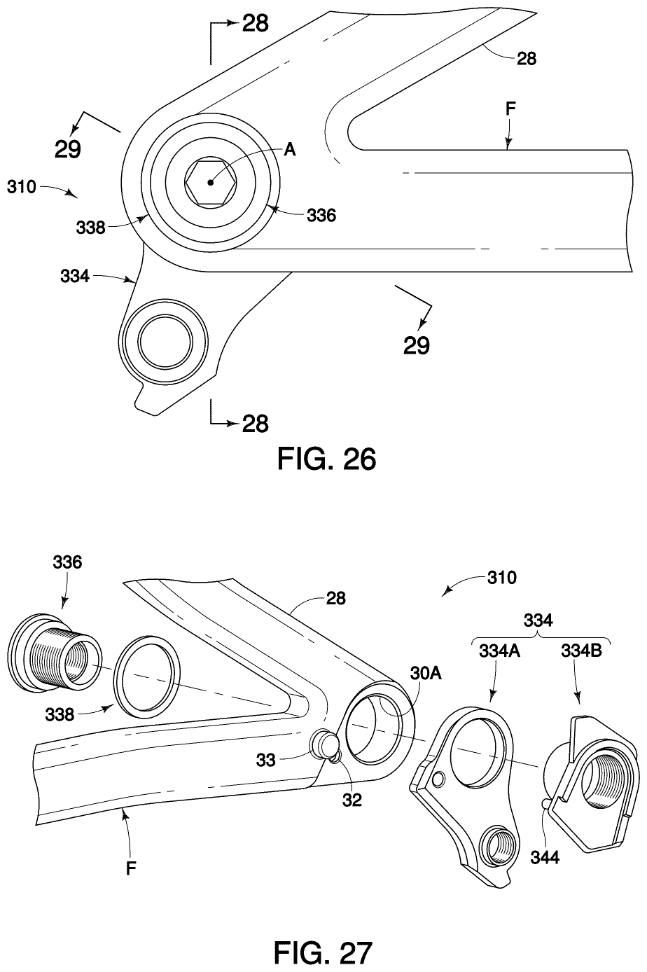

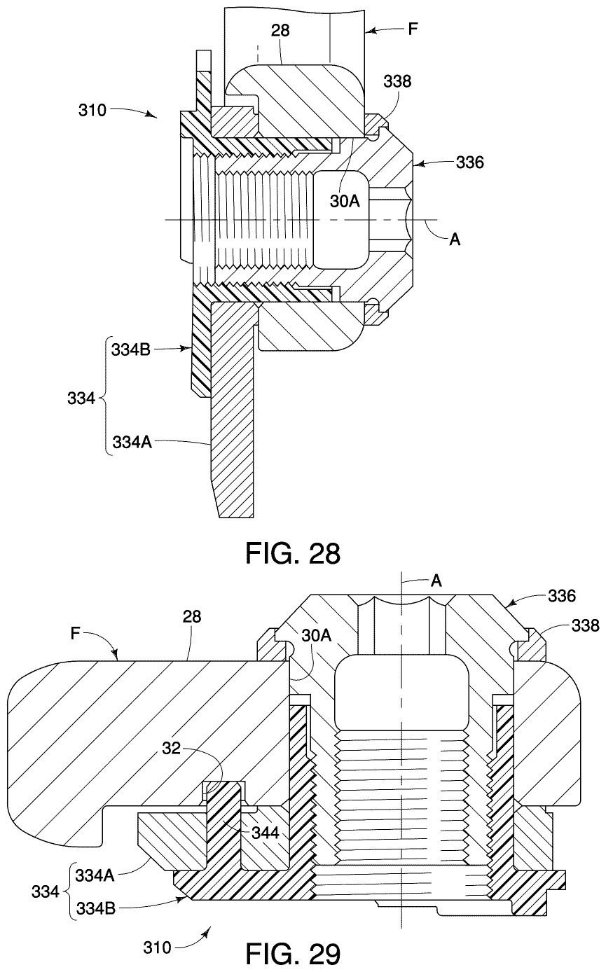

Referring now to FIGS. 24 to 29, a derailleur hanger assembly 310 is illustrated in accordance with a third modification. Basically, the derailleur hanger assembly 310 comprises a derailleur hanger 334, a hanger bolt 336 and a hanger washer 338. The derailleur hanger 334 is provided with a pin 344 to prevent rotation of the derailleur hanger 334 relative to the bicycle frame F until a predetermined force is applied to the derailleur hanger 334 causing the pin 344 to break. Here, the derailleur hanger 334 has a two-piece construction. Namely, the derailleur hanger 334 comprises a first hanger part 334A and a second hanger part 334B. With this modification, the first hanger part 334A can be made of a first material and the second hanger part 334B can be made of a second material that is different from the first material of the first hanger part 334A. For example, the first hanger part 334A is made of a metallic material, while the second hanger part 334B is made of non-metallic material such as plastic. Here, the second hanger part 334B and the pin 344 are integrally formed as a one-piece member. For example, the second hanger part 334B and the pin 344 are molded from a single plastic material to form a one-piece member. Here, the pin 344 is free of a frangible portion. However, the pin 344 can be provided with a frangible portion as needed and/or desired.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts unless otherwise stated.

As used herein, the following directional terms “frame facing side”, “non-frame facing side”, “forward”, “rearward”, “front”, “rear”, “up”, “down”, “above”, “below”, “upward”, “downward”, “top”, “bottom”, “side”, “vertical”, “horizontal”, “perpendicular” and “transverse” as well as any other similar directional terms refer to those directions of a bicycle in an upright, riding position and equipped with the derailleur hanger. Accordingly, these directional terms, as utilized to describe the derailleur hanger should be interpreted relative to a bicycle in an upright riding position on a horizontal surface and that is equipped with the derailleur hanger. The terms “left” and “right” are used to indicate the “right” when referencing from the right side as viewed from the rear of the bicycle, and the “left” when referencing from the left side as viewed from the rear of the bicycle.

The phrase “at least one of” as used in this disclosure means “one or more” of a desired choice. For one example, the phrase “at least one of” as used in this disclosure means “only one single choice” or “both of two choices” if the number of its choices is two. For another example, the phrase “at least one of” as used in this disclosure means “only one single choice” or “any combination of equal to or more than two choices” if the number of its choices is equal to or more than three. Also, the term “and/or” as used in this disclosure means “either one or both of”. For instance, the phrase “at least one of A and B” encompasses (1) A alone, (2), B alone, and (3) both A and B. The phrase “at least one of A, B, and C” encompasses (1) A alone, (2), B alone, (3) C alone, (4) both A and B, (5) both B and C, (6) both A and C, and (7) all A, B, and C. In other words, the phrase “at least one of A and B” does not mean “at least one of A and at least one of B” in this disclosure.

Also, it will be understood that although the terms “first” and “second” may be used herein to describe various components, these components should not be limited by these terms. These terms are only used to distinguish one component from another. Thus, for example, a first component discussed above could be termed a second component and vice versa without departing from the teachings of the present invention.

The term “attached” or “attaching”, as used herein, encompasses configurations in which an element is directly secured to another element by affixing the element directly to the other element; configurations in which the element is indirectly secured to the other element by affixing the element to the intermediate member(s) which in turn are affixed to the other element; and configurations in which one element is integral with another element, i.e. one element is essentially part of the other element. This definition also applies to words of similar meaning, for example, “joined”, “connected”, “coupled”, “mounted”, “bonded”, “fixed” and their derivatives. Finally, terms of degree such as “substantially”, “about” and “approximately” as used herein mean an amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, unless specifically stated otherwise, the size, shape, location or orientation of the various components can be changed as needed and/or desired so long as the changes do not substantially affect their intended function. Unless specifically stated otherwise, components that are shown directly connected or contacting each other can have intermediate structures disposed between them so long as the changes do not substantially affect their intended function. The functions of one element can be performed by two, and vice versa unless specifically stated otherwise. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A derailleur hanger comprising:
a first portion including an axle receiving bore configured to receive a hub axle;
a second portion including a derailleur support surface configured to support a derailleur;
a third portion coupled the first portion and the second portion, the third portion including a first surface facing in a first direction, a second surface facing in a second direction opposite the first direction, and a third surface facing in the first direction; and
a pin including a first part coupled to the third portion, a second part projecting in the first direction from the third surface to be received in a pin receiving portion of a bicycle frame in a mounted state where the derailleur hanger is mounted to the bicycle frame, and a frangible part disposed between the first part and the second part,
the frangible part being configured to break relative to the first part and the second part upon application of a predetermined force or higher to the pin.

2. The derailleur hanger according to claim 1, wherein
the frangible part is disposed at a position between the first surface and the third surface.

3. The derailleur hanger according to claim 1, wherein
the frangible part is configured to be disposed outside of the pin receiving portion of a bicycle frame in the mounted state.

4. The derailleur hanger according to claim 1, wherein
the frangible part includes a groove.

5. The derailleur hanger according to claim 4, wherein
the pin includes a first end and a second end,
the second end is spaced from the first end in the first direction, and
a first distance between the groove and the first end is larger than a second distance between the groove and the second end.

6. The derailleur hanger according to claim 4, wherein
the pin includes a pin axis extending in the first direction and a circumferential surface extending in a circumferential direction around the pin axis, and
the groove extends circumferentially on the circumferential surface to define a continuous groove.

7. The derailleur hanger according to claim 1, wherein
the third surface is offset from the first surface in the second direction, and a pin attachment portion provided on the third surface, and the pin is provided to the pin attachment portion.

8. A derailleur hanger comprising:
a first portion including an axle receiving bore configured to receive a hub axle;
a second portion including a derailleur support surface configured to support a derailleur;
a third portion coupled the first portion and the second portion, the third portion including a first surface facing in a first direction, a second surface facing in a second direction opposite the first direction and a third surface offset from the first surface in the second direction;
a pin attachment portion provided on the third portion; and
a pin including a first part provided to the pin attachment portion, and a second part projecting in the first direction from the third portion to be received in a pin receiving portion of a bicycle frame in a mounted state where the hanger is mounted to the bicycle frame.

9. The derailleur hanger according to claim 7, wherein
the pin attachment portion includes a pin attachment hole, and
the first part of the pin is fixed to the pin attachment hole.

10. The derailleur hanger according to claim 9, wherein
the third surface surrounds the pin attachment hole.

11. The derailleur hanger according to claim 7, wherein
the pin attachment portion has a recess, and the third surface is a bottom surface of the recess.

12. The derailleur hanger according to claim 2, wherein
the second part of the pin has a free end disposed opposite of the third surface with respect to the first surface.

13. The derailleur hanger according to claim 2, further comprising
a first peripheral edge portion disposed between the second surface and the third surface,
the first surface and the third surface being interconnected by a connecting surface, and
the third surface and the first peripheral edge portion defining a corner opposite to the second portion.

14. The derailleur hanger according to claim 2, further comprising
a second peripheral edge portion disposed between the first surface and the second surface, and
the second peripheral edge portion including an inclined surface adjacent to the second surface of the third portion, the inclined surface being configured to aid in attaching and detaching a hub with respect to the hanger.

15. The derailleur hanger according to claim 2, wherein
the first portion includes a frame attachment surface,
the frame attachment surface is configured to contact with the bicycle frame in the mounted state, and
the third surface is offset from the frame attachment surface in the second direction.

16. The derailleur hanger according to claim 2, wherein
the third surface is offset from the derailleur support surface in the second direction.

17. The derailleur hanger according to claim 2, wherein
the derailleur support surface faces in the first direction, and
the derailleur support surface and the third surface are non-overlapping as viewed in a direction parallel to an axial direction of the axle receiving bore.

18. The derailleur hanger according to claim 1, wherein
the pin protrudes relative to the first surface and does not protrude from the second surface.

19. The derailleur hanger according to claim 1, wherein
the first portion includes a tubular part that protrudes relative to the first surface around the axle receiving bore, and
the tubular part is configured to avoid contact with the bicycle frame in the mounted state.

20. The derailleur hanger according to claim 1, further comprising
a first chain restriction portion including a first chain restriction surface;
the first portion including a hub contact surface facing the second direction, and
the first chain restriction surface facing in the second direction and being offset from the second surface in the second direction.

21. The derailleur hanger according to claim 1, wherein
the first portion includes a frame attachment surface,
the frame attachment surface is configured to contact with the bicycle frame in the mounted state, the frame attachment surface is disposed in a plane extending perpendicular to an axial direction of the axle receiving bore, and
the derailleur support surface is disposed in the plane.
